(19) United States
(12) Patent Application Publication
(10) Pub. No.: US 2026/0095352 A1
(43) Pub. Date: Apr. 2, 2026

(54) DECISION FEEDBACK EQUALIZER AND METHOD FOR PERFORMING DECISION FEEDBACK EQUALIZATION ON INPUT SIGNAL IN DECISION FEEDBACK EQUALIZER

(71) Applicant: Realtek Semiconductor Corp., HsinChu (TW)

(72) Inventor: Jun Yang, Suzhou City (CN)

(73) Assignee: Realtek Semiconductor Corp., HsinChu (TW)

(21) Appl. No.: 19/317,115

(22) Filed: Sep. 2, 2025

(30) Foreign Application Priority Data
Sep. 30, 2024 (CN) 202411387973.5

(51) Int. Cl. H04L 25/03

(52) U.S. Cl. CPC H04L 25/03885; H04L 25/03267

(57) ABSTRACT

A decision feedback equalizer (DFE) and a method for performing decision feedback equalization on an input signal in the DFE are provided. The DFE includes a first comparator, a first calculating circuit, a second comparator and a second calculating circuit. The first comparator is configured to compare a first calculation signal with a first threshold to generate a first comparison result, and the first calculating circuit is configured to generate the first calculation signal according to the input signal and a first delayed signal of the first comparison result. The second comparator is configured to compare a second calculation signal with a second threshold to generate a second comparison result, and the second calculating circuit is configured to generate the second calculation signal according to the input signal and a second delayed signal of the second comparison result.

### BACKGROUND OF THE INVENTION

### 1. Field of the Invention

The present invention is related to X-level pulse amplitude modulation (PAMX) circuits, and more particularly, to a decision feedback equalizer (DFE) and a method for performing decision feedback equalization on an input signal in the DFE.

### 2. Description of the Prior Art

A typical non-return-to-zero (NRZ) circuit such as a two-level pulse-amplitude modulation (PAM2) circuit has a differential input signal with two possible states. In comparison with a PAM2 circuit, an X-level pulse-amplitude modulation (PAMX) circuit has a differential input signal with X possible states, where X is a positive integer greater than two. For example, the differential input signal of a PAM3 circuit may have three possible states, and the differential input signal of a PAM4 circuit may have four possible states, where the rest may be deduced by analogy. Taking the PAM3 circuit as an example, the possible states of the differential input signal may include a high level, a middle level, and a low level. When the differential input signal is at a middle level, the PAM3 circuit of the related art typically avoids performing decision feedback equalization operations, which makes an overall decision feedback equalization effect of the PAM3 circuit insufficient.

Furthermore, in order to effectively reduce a circuit area, some calculation circuits or logics can be integrated together. The wiring for integrating the calculation circuits and logics of a decision feedback equalizer (DFE) within the PAMX circuit of the related art will be quite complicated, and therefore not conducive to integrating internal sub-circuits thereof.

Thus, there is a need for a novel DFE, which can solve the problem of the related art without introducing any side effect or in a way that is less likely to introduce side effects.

### SUMMARY OF THE INVENTION

An objective of the present invention is to provide a decision feedback equalizer (DFE) and a method for performing decision feedback equalization on an input signal in the DFE, in order to improve the effect of decision feedback equalization.

Another objective of the present invention is to provide a DFE and a method for performing decision feedback equalization on an input signal in the DFE, in order to solve the related art problem of wiring complexity introduced in circuit integration.

At least one embodiment of the present invention provides a DFE. The DFE comprises a first comparator, a first calculating circuit, a second comparator and a second calculating circuit, where the first calculating circuit is coupled to the first comparator, and the second calculating circuit is coupled to the second comparator. The first comparator is configured to compare a first calculation signal with a first threshold to generate a first comparison result, and the first calculating circuit is configured to generate the first calculation signal according to an input signal and a first delayed signal of the first comparison result. The second comparator is configured to compare a second calculation signal with a second threshold to generate a second comparison result, and the second calculating circuit is configured to generate the second calculation signal according to the input signal and a second delayed signal of the second comparison result.

At least one embodiment of the present invention provides a method for performing decision feedback equalization on an input signal in a DFE. The method comprises: utilizing a first comparator of the DFE to compare a first calculation signal with a first threshold to generate a first comparison result, wherein the first calculation signal is generated according to the input signal and a first delayed signal of the first comparison result by a first calculating circuit of the DFE; and utilizing a second comparator of the DFE to compare a second calculation signal with a second threshold to generate a second comparison result, wherein the second calculation signal is generated according to the input signal and a second delayed signal of the second comparison result by a second calculating circuit of the DFE.

The DFE and the associated method provided by the embodiments of the present invention make respective decision feedback equalization loops independent of each other, in order to ensure that the respective decision feedback equalization loops can have their own decision feedback equalization effects. In addition, under the architecture of these independent decision feedback equalization loops, wiring complexity of a circuit layout will not be greatly increased when integrating calculation circuits into comparators, and is therefore beneficial to overall circuit simplification. Thus, the present invention can solve the problem of the related art without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating two comparators configured to determine states of a differential input signal of a three-level pulse-amplitude modulation (PAM3) circuit according to an embodiment of the present invention.

FIG. 2 is a diagram illustrating a behavior model of a decision feedback equalizer (DFE) within a PAM3 circuit according to an embodiment of the present invention.

FIG. 3 is a diagram illustrating a behavior model of a DFE which utilizes comparators with summation functions according to an embodiment of the present invention.

FIG. 4 is a diagram illustrating a behavior model of a DFE within a PAM3 circuit according to an embodiment of the present invention.

FIG. 5 is a diagram illustrating the DFE shown in FIG. 4 in another aspect.

FIG. 6 is a diagram illustrating circuit implementation of the DFE shown in FIG. 5 according to an embodiment of the present invention.

FIG. 7 is a diagram illustrating a working flow of a method for performing decision feedback equalization on an input signal in a DFE according to an embodiment of the present invention.

### DETAILED DESCRIPTION

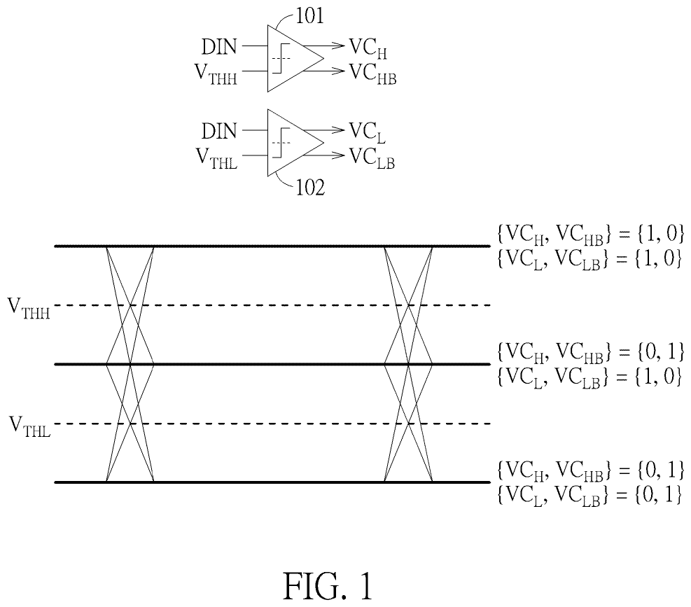

FIG. 1 is a diagram illustrating two comparators 101 and 102 configured to determine states of a differential input signal (e.g. a difference between a pair of differential input signals, which is referred to as an input signal DIN for brevity) of a three-level pulse-amplitude modulation (PAM3) circuit according to an embodiment of the present invention, where the comparator 101 is configured to determine whether the input signal DIN is greater than a threshold V_{THH} to generate output signals {VC_{H}, VC_{HB}}, and the comparator 102 is configured to determine whether the input signal DIN is less than the threshold V_{THL} to generate output signals {VC_{L}, VC_{LB}}, where the threshold V_{THH} is greater than the threshold V_{THL}. In this embodiment, when the input signal DIN falls in an interval greater than the threshold V_{THH}, the comparator 101 may determine that the input signal DIN is greater than the threshold V_{THH} and the comparator 102 may determine that the input signal DIN is greater than the threshold V_{THL}, where the output signals {VC_{H}, VC_{HB}} generated by the comparator 101 is {1, 0} and the output signals {VC_{L}, VC_{LB}} generated by the comparator 102 is {1, 0}, which indicate that the input signal DIN is at a high level state (which is referred to as a HIGH state for brevity). When the input signal DIN falls in an interval which is less than the threshold V_{THH} but greater than the threshold V_{THL}, the comparator 101 may determine that the input signal DIN is less than the threshold V_{THH} and the comparator 102 may determine that the input signal DIN is greater than the threshold V_{THL}, where the output signals {VC_{H}, VC_{HB}} generated by the comparator 101 is {0, 1} and the output signals {VC_{L}, VC_{LB}} generated by the comparator 102 is {1, 0}, which indicate that the input signal DIN is at a middle level state (which is referred to as a MID state for brevity). When the input signal DIN falls in an interval less than the threshold V_{THL}, the comparator 101 may determine that the input signal DIN is less than the threshold V_{THH} and the comparator 102 may determine that the input signal DIN is less than the threshold V_{THL}, where the output signals {VC_{H}, VC_{HB}} generated by the comparator 101 are {0, 1} and the output signals {VC_{H}, VC_{LB}} generated by the comparator 102 are {0, 1}, which indicate that the input signal DIN is at a low level state (which is referred to as a LOW state).

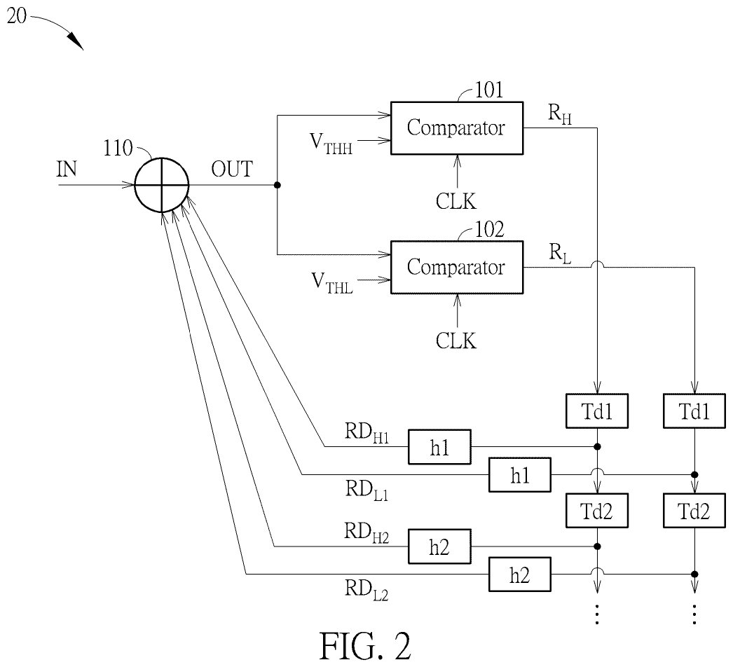

FIG. 2 is a diagram illustrating a behavior model of a decision feedback equalizer (DFE) 20 within the PAM3 circuit according to an embodiment of the present invention. As shown in FIG. 2, the DFE 20 may comprise the comparators 101 and 102 and a calculating circuit such as a summation circuit 110, where the summation circuit 110 is coupled to the comparators 101 and 102. It should be noted that signals involved in operations of the DFE 20 shown in FIG. 2 may be differential signals, and these differential signals are illustrated by single-ended signals (e.g. a difference between each pair of differential signals) for brevity, as shown by an input signal IN, a calculation signal such as a summation signal OUT, output signals R_{H} and R_{L}, and delayed signals RD_{H1}, RD_{L1}, RD_{H2} and RD_{L2}. For example, the output signal Ru may represent a difference between the output signals {VC_{H}, VC_{HB}} (e.g. R_{H}=VC_{H}−VC_{HB}), and the output signal R_{L} may represent a difference between the output signals {VC_{L}, VC_{LB}} (e.g. R_{L}=VC_{L}−VC_{LB}). In this embodiment, the comparator 101 is configured to compare the summation signal OUT with the threshold V_{THH} to generate a comparison result such as the output signal R_{H}, and the comparator 102 is configured to compare the summation signal OUT with the threshold V_{THL} to generate a comparison result such as the output signal R_{L}, where the summation circuit 110 is configured to generate the summation signal OUT according to the input signal IN, a delayed signal (e.g. RD_{H1} and RD_{H2}) of the output signal R_{H}, and a delayed signal (e.g. RD_{L1} and RD_{L2}) of the output signal R_{L}. In particular, the summation circuit 110 may perform calculation (e.g. summation) on the input signal IN and the delayed signal RD_{H1}, RD_{H2}, RD_{L1} and RD_{L2} to generate the summation signal OUT, where the delayed signal RD_{H1} is generated by applying a first predetermined delay (e.g. Td1) to the output signal R_{H} and multiplying by a first predetermined coefficient (e.g. h1), the delayed signal RD_{H2} is generated by applying a second predetermined delay (e.g. Td1+Td2) to the output signal R_{H} and multiplying by a second predetermined coefficient (e.g. h2), the delayed signal RD_{L1} is generated by applying the first predetermined delay (e.g. Td1) to the output signal R_{L} and multiplying by the first predetermined coefficient (e.g. h1), and the delayed signal RD_{L2} is generated by applying the second predetermined delay (e.g. Td1+Td2) to the output signal R_{L} and multiplying by the second predetermined coefficient (e.g. h2).

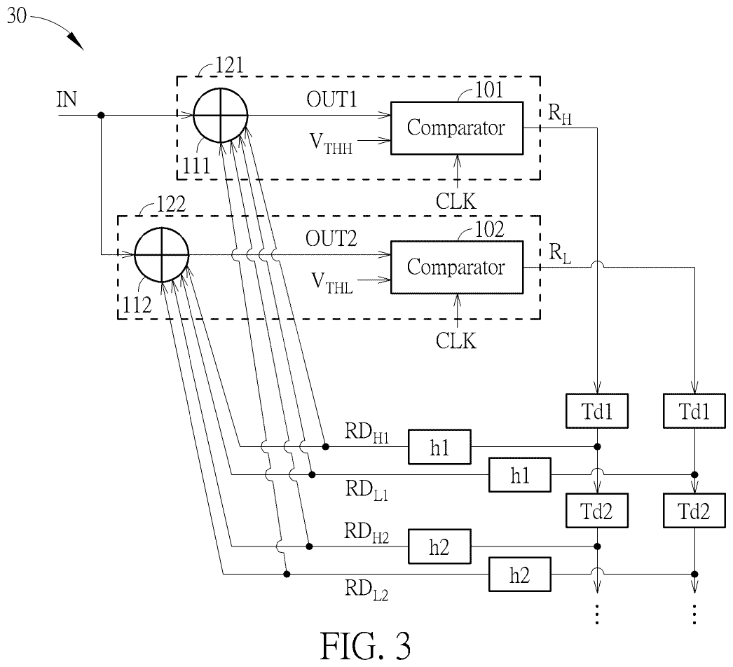

It should be noted that, when the summation signal OUT is at the MID state in a certain cycle of a clock signal CLK, the output signals R_{H} and R_{L} generated in this cycle are unable to have decision feedback equalization effects on the input signal IN (e.g. feedbacks of the output signal R_{H} and R_{L} may cancel each other), which makes an effect of the decision feedback equalization provided by the DFE 20 insufficient. Furthermore, in some designs, functions of the summation circuit 110 may be integrated into input stages of the comparators 101 and 102. FIG. 3 is a diagram illustrating a behavior model of a DFE 30 within the PAM3 circuit which utilizes comparators with summation functions according to an embodiment of the present invention. The DFE 30 may comprise comparators 121 and 122 which are equipped with calculation functions such as summation functions, where the comparator 121 may comprise a calculating circuit such as a summation circuit 111 and the comparator 101, and the comparator 122 may comprise a calculating circuit such as a summation circuit 112 and the comparator 102. In particular, the summation circuit 111 is configured to execute operations of the summation circuit 110 shown by FIG. 2 in the comparator 121 to generate the summation signal OUT1, and the summation circuit 112 is configured to execute operations of the summation circuit 110 shown by FIG. 2 in the comparator 122 to generate the summation signal OUT2. As shown in FIG. 3, both the comparators 121 and 122 need to receive the delayed signal RD_{H1}, RD_{H2}, RD_{L1} and RD_{L2}, and overall wirings therefore become quite complicated. This makes it difficult to simplify the DFE 20 by integrating a summing operation and a comparing operation into a single circuit.

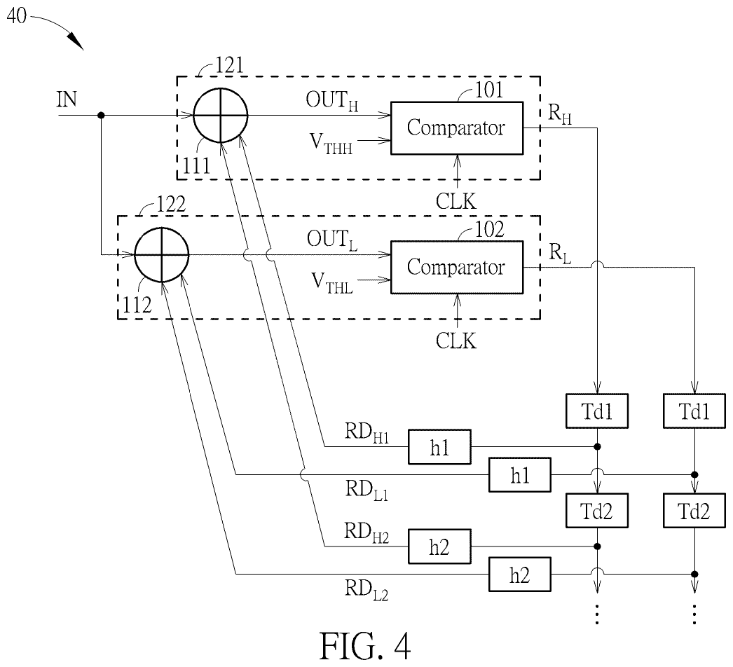

FIG. 4 is a diagram illustrating a behavior model of a DFE 40 within the PAM3 circuit according to an embodiment of the present invention. As shown in FIG. 4, the DFE 40 may comprise the comparator 101, a first calculating circuit such as the summation circuit 111, the comparator 102 and a second calculating circuit such as the summation circuit 112, where the summation circuit 111 is coupled to the comparator 101, and the summation circuit 112 is coupled to the comparator 102. In this embodiment, the comparator 101 is configured to compare a first calculation signal such as a summation signal OUT_{H} with the threshold V_{THH} to generate a first comparison result such as the output signal R_{H}, and the summation circuit 111 is configured to generate the summation signal OUT_{H} according to the input signal IN and a first delayed signal (e.g. the delayed signal RD_{H1} and RD_{H2}) of the output signal R_{H}. In addition, the comparator 102 is configured to compare a second calculation signal such as a summation signal OUT_{L} with the threshold V_{THL} to generate a second comparison result such as the output signal R_{L}, and the summation circuit 112 is configured to generate the summation signal OUT_{L} according to the input signal IN and a second delayed signal (e.g. the delayed signal RD_{L1} and RD_{L2}) of the output signal R_{L}.

Similar to the embodiment of FIG. 2, the delayed signal RD_{H1} is generated by applying the first predetermined delay (e.g. Td1) to the output signal Ru and multiplying by the first predetermined coefficient (e.g. h1), the delayed signal RD_{H2} is generated by applying the second predetermined delay (e.g. Td1+Td2) to the output signal R_{H} and multiplying by the second predetermined coefficient (e.g. h2), the delayed signal RD_{L1} is generated by applying the first predetermined delay (e.g. Td1) to the output signal RI, and multiplying by the first predetermined coefficient (e.g. h1), and the delayed signal RD_{L2} is generated by applying the second predetermined delay (e.g. Td1+Td2) to the output signal R_{L} and multiplying by the second predetermined coefficient (e.g. h2). It should be noted that, in this embodiment, the summation circuit 111 is configured to perform calculation (e.g. summation) on the input signal IN and the first delayed signal (e.g. the delayed signal RD_{H1} and RD_{H2} to generate the summation signal OUT_{H}. As the summation circuit 111 will not receive the second delayed signal (e.g. the delayed signal RD_{L1} and RD_{L2}), the summation signal OUT_{H} output by the summation circuit 111 is related to the input signal IN and the output signal R_{H} only (i.e. related to the delayed signal RD_{H1} and RD_{L2}), and is unrelated to the output signal R_{L} (i.e. unrelated to the delayed signal RD_{L1} and RD_{L2}). In addition, the summation circuit 112 is configured to perform calculation (e.g. summation) on the input signal IN and the second delayed signal (e.g. the delayed signal RD_{L1} and RD_{L2}) to generate the summation signal OUT_{L}. As the summation circuit 112 will not receive the first delayed signal (e.g. the delayed signal RD_{H1} and RD_{H2}), the summation signal OUT_{L} output by the summation circuit 112 is related to the input signal IN and the output signal R_{L} (i.e. related to the delayed signal RD_{L1} and RD_{L2}) only, and is unrelated to the output signal R_{H} (i.e. unrelated to the delayed signal RD_{H1} and RD_{H2}).

In this embodiment, operations of the summation circuit 111 and the comparator 101 may be integrated into the comparator 121 equipped with the calculation function such as the summation function, and operations of the summation circuit 112 and the comparator 102 may be integrated into the comparator 122 equipped with the calculation function such as the summation function. In comparison with the DFE 20 shown in FIG. 2, the DFE 40 shown in FIG. 4 is more favorable to the purpose of integrating the summation operation and the comparing operation into a single circuit for circuit simplification.

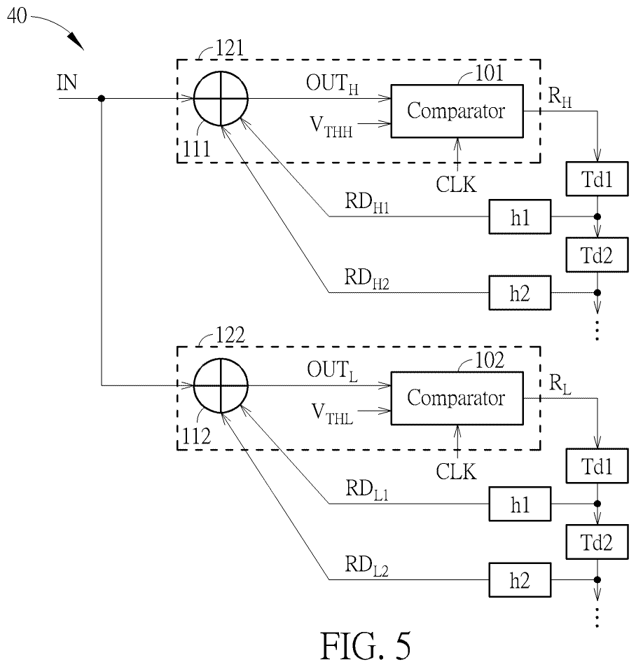

FIG. 5 is a diagram illustrating the DFE 40 shown in FIG. 4 in another aspect. As shown in FIG. 5, an output of the comparator 121 (i.e. the output signal R_{H}) may be fed back to an input of the comparator 121 (e.g. an input of the summation circuit 111) only, and an output of the comparator 122 (i.e. the output signal R_{L}) may be fed back to an input of the comparator 122 (e.g. an input of the summation circuit 112) only. Thus, the comparators 121 and 122 have respective independent decision feedback equalization loops and will not affect each other. Even if the summation signal OUT_{H} or OUT_{L} is at the MID state (e.g. falls in the interval which is less than the threshold V_{THH} but higher than V_{THL}), each of the comparators 121 and 122 can still perform the decision feedback equalization on the input signal IN. For example, the summation signal OUT_{H} generated by the summation circuit 111 may have a better upper eye diagram due to the decision feedback equalization performed by the comparator 121, and the summation signal OUT_{L} generated by the summation circuit 112 may have a better lower eye diagram due to the decision feedback equalization performed by the comparator 122. It should be noted that the number of taps of the DFE 40 is not limited to that of the architecture shown in FIG. 4 or FIG. 5. In some embodiment, the number of taps of the DFE 40 may vary, and architectures with different numbers of taps may be deduced by analogy.

In the decision feedback equalization loop of the comparator 121, when the summation signal OUT_{H} is greater than the threshold V_{THH}, the summation circuit 111 may decrease the summation signal OUT_{H} according to a first logic state of the output signal R_{H} (e.g. {VC_{H}, VC_{HB}}={1, 0}), and when the summation signal OUT_{H} is less than the threshold V_{THH}, the summation circuit 111 may increase the summation signal OUT_{H} according to a second logic state of the output signal R_{H} (e.g. {VC_{H}, VC_{HB}}={0, 1}). In the decision feedback equalization loop of the comparator 122, when the summation signal OUT_{L} is greater than the threshold V_{THL}, the summation circuit 112 may decrease the summation signal OUT_{L} according to a first logic state of the output signal R_{L} (e.g. {VC_{L}, VC_{LB}}={1, 0}), and when the summation signal OUT_{L} is less than the threshold V_{THL}, the summation circuit 112 may increase the summation signal OUT_{L} according to a second logic state of the output signal R_{L} (e.g. {VC_{L}, VC_{LB}}={0, 1}).

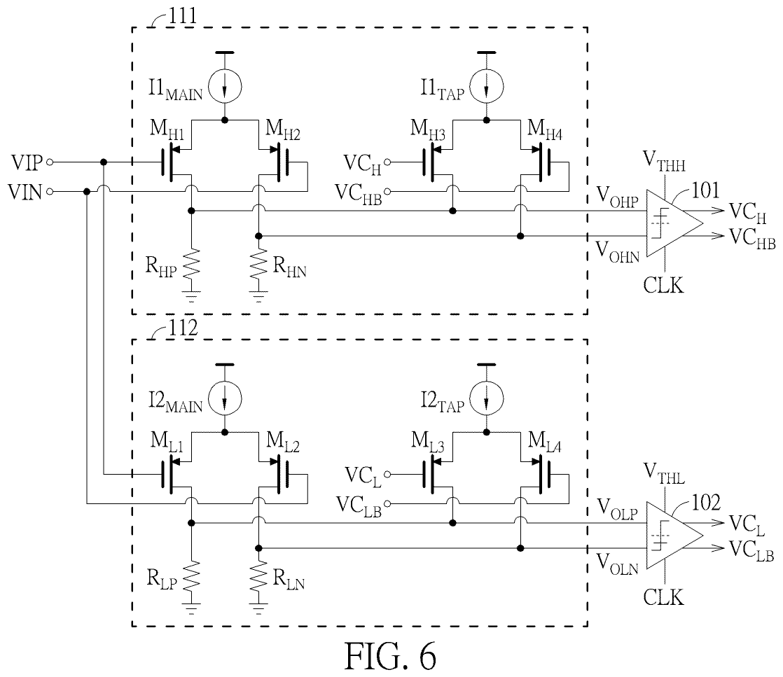

FIG. 6 is a diagram illustrating circuit implementation of the DFE 40 shown in FIG. 5 according to an embodiment of the present invention. As shown in FIG. 6, the summation circuit 111 of the DFE 40 may comprise at least one first transistor (e.g. transistors M_{H1} and M_{H2}) and at least one second transistor (e.g. transistors M_{H3} and M_{H4}), where drain terminals of the transistors M_{H1} and M_{H2} and drain terminals of the transistor M_{H3} and M_{H4} are coupled to input terminals of the comparator 101. In this embodiment, the at least one first transistor (e.g. the transistors M_{H1} and M_{H2}) is configured to receive the input signal IN (e.g. the transistor M_{H1} is configured to receive an input signal VIP and the transistor M_{H2} is configured to receive an input signal VIN), where the input signal IN may represent a difference between the input signals {VIP, VIN} (e.g. IN=VIP−VIN). The at least one second transistor (e.g. the transistors M_{H3} and M_{H4}) is configured to receive the first comparison result such as the output signal R_{H} (e.g. the transistor M_{H3} is configured to receive the output signal VC_{H} and the transistor M_{H4} is configured to receive the output signal VC_{HB}), where the output signal Ru may represent a difference between the output signals {VC_{H}, VC_{HB}} (e.g. R_{H}=VC_{H}−VC_{HB}). More particularly, the at least one first transistor (e.g. the transistors M_{H1} and M_{H2}) and the at least one second transistor (e.g. the transistors M_{H3} and M_{H4}) perform current summation on the input terminals of the comparator 101 to generate the summation signal OUT_{H} (e.g. generating a summation signal V_{OHP} on the drain terminals of the transistor M_{H1} and M_{H2} and generating a summation signal V_{OHP} on the drain terminals of the transistor M_{H2} and M_{H4}), where the summation signal OUT_{H} may represent a difference between the summation signals {V_{OHP}, V_{OHN}} (e.g. OUT_{H}=V_{OHP}−V_{OHN}). In addition, the summation circuit 112 of the DFE 40 may comprise at least one third transistor (e.g. transistors M_{L1} and M_{L2}) and at least one fourth transistor (e.g. transistors M_{L3} and M_{L4}), where drain terminals of the transistors M_{L1} and M_{L2} and drain terminals of the transistor M_{L3} and M_{L4} are coupled to input terminals of the comparator 102. In this embodiment, the at least one third transistor (e.g. the transistor M_{L1} and M_{L2}) is configured to receive the input signal IN (e.g. the transistor Mui is configured to receive the input signal VIP and the transistor M_{L2} is configured to receive the input signal VIN). The at least one fourth transistor (e.g. the transistor M_{L3} and M_{L4}) is configured to receive the second comparison result such as the output signal R_{L} (e.g. the transistor M_{L3} is configured to receive the output signal VC_{L} and the transistor M_{L4} is configured to receive the output signal VC_{LB}), where the output signal R_{L} may represent a difference between the output signals {VC_{L}, VC_{LB}} (e.g. R_{L}=VC_{L}−VC_{LB}). More particularly, the at least one third transistor (e.g. the transistors M_{L1} and M_{L2}) and the at least one fourth transistor (e.g. the transistors M_{L3} and M_{L4}) perform current summation on the input terminals of the comparator 102 to generate the summation signal OUT_{L} (e.g. generating a summation signal V_{OLP} on the drain terminals of the transistors M_{L1} and M_{L3} and generating a summation signal V_{OLN} on the drain terminal of the transistors M_{L2} and M_{L4}), where the summation signal OUT_{L} may represent a difference between the summation signals {V_{OLP}, V_{OLN}} (e.g. OUT_{L}=V_{OLP}−V_{OLN}).

In particular, the drain terminals of the transistors M_{H1} and M_{H3} are coupled to a resistor R_{HP}, and the drain terminals of the transistor M_{H2} and M_{H4} are coupled to a resistor R_{HN}, where source terminals of the transistors M_{H1} and M_{H2} are coupled to a current source I1_{MAIN}, and source terminals of the transistors M_{H3} and M_{H4} are coupled to a current source I1_{TAP}. Thus, the input signals VIP and VIN may control a ratio of currents flowing to the resistors R_{HP} and R_{HN} from the current source I1_{MAN}, and the output signal VC_{H} and VC_{HB} may control a ratio of currents flowing to the resistors R_{HP} and R_{HN} from the current source I1_{TAP}. In addition, the drain terminals of the transistors M_{L1} and M_{L3} are coupled to a resistor R_{LP}, and the drain terminals of the transistor M_{L2} and M_{L4} are coupled to a resistor R_{LN}, where source terminals of the transistors M_{L1} and M_{L2} are coupled to the current source I2_{MAIN}, and source terminals of the transistors M_{L3} and M_{L4} are coupled to the current source I2_{TAP}. Thus, the input signals VIP and VIN may control a ratio of currents flowing to the resistor R_{LP} and R_{LN} from the current source I2_{MAIN}, and the output signals VC_{L} and VC_{LB} may control a ratio of currents flowing to the resistors R_{LP} and R_{LN} from the current source I2_{TAP}.

In addition, the predetermined delay Td1 shown in FIG. 5 may be implemented by controlling timing of transmitting the output signals VC_{H} and VC_{HB} to gate terminals of the transistors M_{H3} and M_{H4} based on the clock signal CLK (or controlling timing of transmitting the output signals VC_{L} and VC_{LB} to gate terminals of the transistors M_{L3} and M_{L4}), and the predetermined coefficient h1 shown in FIG. 5 may be determined by a ratio of the current of the current source I1_{MAIN} and the current of the current source I1_{TAP} (or a ratio of the current of the current source I2_{MAIN} and the current of the current source I2_{TAP}), but the present invention is not limited thereto. It should be noted that FIG. 6 merely shows the implementation of one-tap architecture, and more particularly, merely shows the implementation of performing the decision feedback equalization based on the delayed signals RD_{H1} and RD_{L1}, where the implementation of performing the decision feedback equalization based on the delayed signals RD_{H2} and RD_{H2} is omitted in FIG. 6 for brevity, and those skilled in this art should be able to deduce by analogy how to implement multi-tap architecture (e.g. 1.5-tap architecture which may be referred to as TAP-1.5, two-tap architecture which may be referred to as TAP-2) according to the one-tap architecture shown in FIG. 6.

As mentioned above, the at least one second transistor may comprise the transistors M_{H3} and M_{H4}, and the summation signal OUT_{H} shown in FIG. 5 may represent a difference between a first positive calculation signal (e.g. the summation signal V_{OHP}) on the drain terminal of the transistor M_{H3} and a first negative calculation signal (e.g. the summation signal V_{OHN}) on the drain terminal of the transistor M_{H4}, such as the summation signal OUT_{H} (e.g. OUT_{H}=V_{OHP}−V_{OHN}). When the difference such as the summation signal OUT_{H} is greater than the threshold V_{THH}, the transistor M_{H4} may be turned on (e.g. conductive) in response to a first logic state of the output signals {VC_{H}, VC_{HB}} (e.g. {VC_{H}, VC_{HB}}={1, 0}) and the transistor Mus may be turned off (e.g. non-conductive) in response to {VC_{H}, VC_{HB}}={1, 0}), in order to add a unit feedback signal (e.g. a feedback signal corresponding to the current of the current source I1_{TAP}) to the summation signal V_{OHN} for decreasing the first calculation signal such as the summation signal OUT_{H} (e.g. decreasing (V_{OHP}−V_{OHN})). When the difference such as the summation signal OUT_{H} is less than the threshold V_{THH}, the transistor M_{H3} may be turned on in response to a second logic state of the output signals {VC_{H}, VC_{HB}} (e.g. {VC_{H}, VC_{HB}}={0, 1}) and the transistor M_{H4} may be turned off in response to {VC_{H}, VC_{HB}}={0, 1}, in order to add the unit feedback signal (e.g. the feedback signal corresponding to the current of the current source I1_{TAP}) to the summation signal V_{OHP}, for increasing the first calculation signal such as the summation signal OUT_{H} (e.g. increasing (V_{OHP}−V_{OHN})).

In addition, the at least one fourth transistor may comprise the transistors M_{L3} and M_{L4}, and the summation signal OUT_{L} shown in FIG. 5 may represent a difference between a second positive calculation signal (e.g. the summation signal V_{OLP}) on the drain terminal of the transistor M_{L3} and a second negative calculation signal (e.g. the summation signal V_{OLN}) on the drain terminal of the transistor M_{L4}, such as the summation signal OUT_{L} (e.g. OUT_{L}=V_{OLP}−V_{OLN}). When the difference such as the summation signal OUT_{L} is greater than the threshold V_{THL}, the transistor M_{L4} may be turned on in response to a first logic state of the output signals {VC_{L}, VC_{LB}} (e.g. {VC_{L}, VC_{LB}}={1, 0}) and the transistor M_{L3} may be turned off in response to {VC_{L}, VC_{LB}}={1, 0}, in order to add a unit feedback signal (e.g. a feedback signal corresponding to the current of the current source I2_{TAP}) to the summation signal V_{OLN} for decreasing the second calculation signal such as the summation signal OUT_{L} (e.g. decreasing (V_{OLP}−V_{OLN})). When the difference such as the summation signal OUT_{L} is less than the threshold V_{THL}, the transistor M_{L3} may be turned on in response to a second logic state of the output signals {VC_{L}, VC_{LB}} (e.g. {VC_{L}, VC_{LB}}={0, 1} and the transistor M_{L4} may be turned off in response to {VC_{L}, VC_{LB}}={0, 1}, in order to add the unit feedback signal (e.g. the feedback signal corresponding to the current of the current source I2_{TAP}) to the summation signal V_{OLP} for increasing the second calculation signal such as the summation signal OUT_{L} (e.g. increasing (V_{OLP}−V_{OLN})).

It should be noted that the DFE 40 provided by the embodiment of the present invention is applied to the PAM3 circuit as an example, but the present invention is not limited thereto. For example, a DFE applied to a PAM4 circuit may be implemented by modifying the number of comparators and the number of decision feedback equalization loops within the DFE 40, and related details are omitted here for brevity. In addition, feedback operations of the feedback signals (e.g. the delayed signal RD_{H1}, RD_{H2}, RD_{L1} and RD_{L2}) performed on the summation signal OUT_{H} and OUT_{L} by the summation circuits 111 and 112 may be summation or subtraction. In addition, the summation circuits 111 and 112 of the present invention are not limited to implementation of current mode logics (CMLs) with P-type transistor inputs. In some embodiment, the summation circuits 111 and 112 may be implemented by CMLs with N-type transistor inputs. In addition, loop architectures of the DFE 20 and the DFE 40 may be combined. In addition, a relationship between a data rate and a clock rate of the DFE 40 is not limited to specific ratios. For example, the DFE 40 may be a full-rate DFE, a half-rate DFE or a quarter-rate DFE.

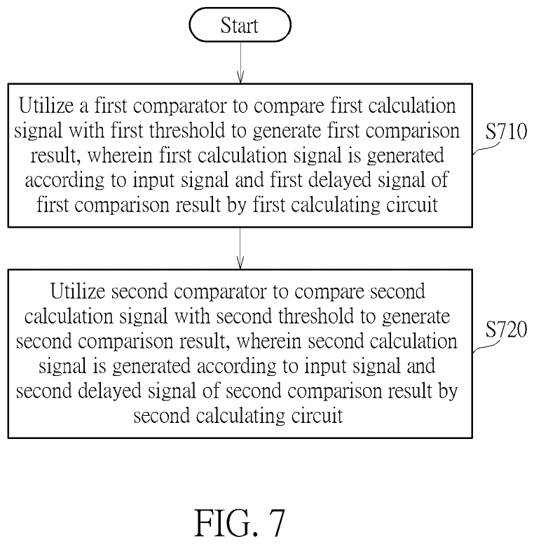

FIG. 7 is a diagram illustrating a working flow of a method for performing decision feedback equalization on an input signal in a DFE (e.g. the DFE 40 shown in FIG. 4 or FIG. 5) according to an embodiment of the present invention. It should be noted that the working flow shown in FIG. 7 is for illustrative purposes only, and is not meant to be a limitation of the present invention. For example, one or more steps may be added, deleted or modified in the working flow shown in FIG. 7. In addition, if a same result may be obtained, these steps do not have to be executed in the exact order shown in FIG. 7.

In Step S710, the DFE may utilize a first comparator therein to compare a first calculation signal with a first threshold to generate a first comparison result, wherein the first calculation signal is generated according to the input signal and a first delayed signal of the first comparison result by a first calculating circuit of the DFE.

In Step S720, the DFE may utilize a second comparator therein to compare a second calculation signal with a second threshold to generate a second comparison result, wherein the second calculation signal is generated according to the input signal and a second delayed signal of the second comparison result by a second calculating circuit of the DFE.

To summarize, the DFE 40 provided by the embodiments of the present invention makes each decision feedback equalization loop composed of a comparator and a calculation circuit (e.g. a summation circuit) independent of each other, thereby ensuring that each decision feedback equalization loop can introduce its own decision feedback equalization effect. In addition, in the architecture where these decision feedback equalization loops are independent of each other, when the summation circuit is integrated into the comparator, the wiring complexity of the circuit layout will not be greatly increased, which is more conducive to the simplification of the overall circuit. Thus, the present invention can solve the problems of the related art without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A decision feedback equalizer (DFE), comprising:
a first comparator, configured to compare a first calculation signal with a first threshold to generate a first comparison result;
a first calculating circuit, coupled to the first comparator, configured to generate the first calculation signal according to an input signal and a first delayed signal of the first comparison result;
a second comparator, configured to compare a second calculation signal with a second threshold to generate a second comparison result; and
a second calculating circuit, coupled to the second comparator, configured to generate the second calculation signal according to the input signal and a second delayed signal of the second comparison result.

2. The DFE of claim 1, wherein the first calculating circuit is configured to perform calculation on the input signal and the first delayed signal to generate the first calculation signal, and the second calculating circuit is configured to perform calculation on the input signal and the second delayed signal to generate the second calculation signal.

3. The DFE of claim 1, wherein the first delayed signal is generated by applying a predetermined delay to the first comparison result and multiplying by a predetermined coefficient, and the second delayed signal is generated by applying the predetermined delay to the second comparison result and multiplying by the predetermined coefficient.

4. The DFE of claim 1, wherein:
when the first calculation signal is greater than the first threshold, the first calculating circuit decreases the first calculation signal according to a first logic state of the first comparison result; and
when the first calculation signal is less than the first threshold, the first calculating circuit increases the first calculation signal according to a second logic state of the first comparison result.

5. The DFE of claim 1, wherein:
when the second calculation signal is greater than the second threshold, the second calculating circuit decreases the second calculation signal according to a first logic state of the second comparison result; and
when the second calculation signal is less than the second threshold, the second calculating circuit increases the second calculation signal according to a second logic state of the second comparison result.

6. The DFE of claim 1, wherein:
the first calculating circuit comprises:
at least one first transistor, configured to receive the input signal, wherein a drain terminal of the at least one first transistor is coupled to an input terminal of the first comparator; and
at least one second transistor, configured to receive the first comparison result, wherein a drain terminal of the at least one second transistor is coupled to the input terminal of the first comparator;
wherein the at least one first transistor and the at least one second transistor perform current summation to generate the first calculation signal on the input terminal of the first comparator; and
the second calculating circuit comprises:
at least one third transistor, configured to receive the input signal, wherein a drain terminal of the at least one third transistor is coupled to an input terminal of the second comparator; and
at least one fourth transistor, configured to receive the second comparison result, wherein a drain terminal of the at least one fourth transistor is coupled to the input terminal of the second comparator;
wherein the at least one third transistor and the at least one fourth transistor perform current summation to generate the second calculation signal on the input terminal of the second comparator.

7. The DFE of claim 6, wherein:
the at least one second transistor comprises a second positive transistor and a second negative transistor, and the first calculation signal represents a difference between a first positive calculation signal on a drain terminal of the second positive transistor and a first negative calculation signal on a drain terminal of the second negative transistor;
when the difference is greater than the first threshold, the second negative transistor is turned on in response to a first logic state of the first comparison result to add a unit feedback signal to the first negative calculation signal for decreasing the first calculation signal; and
when the difference is less than the first threshold, the second positive transistor is turned on in response to a second logic state of the first comparison result to add the unit feedback signal to the first positive calculation signal for increasing the first calculation signal.

8. The DFE of claim 6, wherein:
the at least one fourth transistor comprises a fourth positive transistor and a fourth negative transistor, and the second calculation signal represents a difference between a second positive calculation signal on a drain terminal of the fourth positive transistor and a second negative calculation signal on a drain terminal of the fourth negative transistor;
when the difference is greater than the second threshold, the fourth negative transistor is turned on in response to a first logic state of the second comparison result to add a unit feedback signal to the second negative calculation signal for decreasing the second calculation signal; and
when the difference is less than the second threshold, the fourth positive transistor is turned on in response to a second logic state of the second comparison result to add the unit feedback signal to the second positive calculation signal for increasing the second calculation signal.

9. A method for performing decision feedback equalization on an input signal in a decision feedback equalizer (DFE), comprising:
utilizing a first comparator of the DFE to compare a first calculation signal with a first threshold to generate a first comparison result, wherein the first calculation signal is generated according to the input signal and a first delayed signal of the first comparison result by a first calculating circuit of the DFE; and
utilizing a second comparator of the DFE to compare a second calculation signal with a second threshold to generate a second comparison result, wherein the second calculation signal is generated according to the input signal and a second delayed signal of the second comparison result by a second calculating circuit of the DFE.

10. The method of claim 9, wherein the first calculation signal is generated by performing calculation on the input signal and the first delayed signal, and the second calculation signal is generated by performing calculation on the input signal and the second delayed signal.

11. The method of claim 9, wherein the first delayed signal is generated by applying a predetermined delay to the first comparison result and multiplying by a predetermined coefficient, and the second delayed signal is generated by applying the predetermined delay to the second comparison result and multiplying by the predetermined coefficient.

12. The method of claim 9, further comprising:
in response to the first calculation signal being greater than the first threshold, utilizing the first calculating circuit to decrease the first calculation signal according to a first logic state of the first comparison result.

13. The method of claim 9, further comprising:
in response to the first calculation signal being less than the first threshold, utilizing the first calculating circuit to increase the first calculation signal according to a second logic state of the first comparison result.

14. The method of claim 9, further comprising:
in response to the second calculation signal being greater than the second threshold, utilizing the second calculating circuit to decrease the second calculation signal according to a first logic state of the second comparison result.

15. The method of claim 9, further comprising:
in response to the second calculation signal being less than the second threshold, utilizing the second calculating circuit to increase the second calculation signal according to a second logic state of the second comparison result.

16. The method of claim 9, further comprising:
utilizing at least one first transistor of the first calculating circuit to receive the input signal, wherein a drain terminal of the at least one first transistor is coupled to an input terminal of the first comparator;
utilizing at least one second transistor of the first calculating circuit to receive the first comparison result, wherein a drain terminal of the at least one second transistor is coupled to the input terminal of the first comparator;
utilizing the at least one first transistor and the at least one second transistor to perform current summation to generate the first calculation signal on the input terminal of the first comparator;
utilizing at least one third transistor of the second calculating circuit to receive the input signal, wherein a drain terminal of the at least one third transistor is coupled to an input terminal of the second comparator;
utilizing at least one fourth transistor of the second calculating circuit to receive the second comparison result, wherein a drain terminal of the at least one fourth transistor is coupled to the input terminal of the second comparator; and
utilizing the at least one third transistor and the at least one fourth transistor to perform current summation to generate the second calculation signal on the input terminal of the second comparator.

17. The method of claim 16, wherein the at least one second transistor comprises a second positive transistor and a second negative transistor, the first calculation signal represents a difference between a first positive calculation signal on a drain terminal of the second positive transistor and a first negative calculation signal on a drain terminal of the second negative transistor, and the method further comprises:
in response to the difference being greater than the first threshold, turning on the second negative transistor in response to a first logic state of the first comparison result to add a unit feedback signal to the first negative calculation signal for decreasing the first calculation signal.

18. The method of claim 16, wherein the at least one second transistor comprises a second positive transistor and a second negative transistor, the first calculation signal represents a difference between a first positive calculation signal on a drain terminal of the second positive transistor and a first negative calculation signal on a drain terminal of the second negative transistor, and the method further comprises:
in response to the difference being less than the first threshold, turning on the second positive transistor in response to a second logic state of the first comparison result to add the unit feedback signal to the first positive calculation signal for increasing the first calculation signal.

19. The method of claim 16, wherein the at least one fourth transistor comprises a fourth positive transistor and a fourth negative transistor, the second calculation signal represents a difference between a second positive calculation signal on a drain terminal of the fourth positive transistor and a second negative calculation signal on a drain terminal of the fourth negative transistor, and the method further comprises:
in response to the difference being greater than the second threshold, turning on the fourth negative transistor in response to a first logic state of the second comparison result to add a unit feedback signal to the second negative calculation signal for decreasing the second calculation signal.

20. The method of claim 16, wherein the at least one fourth transistor comprises a fourth positive transistor and a fourth negative transistor, the second calculation signal represents a difference between a second positive calculation signal on a drain terminal of the fourth positive transistor and a second negative calculation signal on a drain terminal of the fourth negative transistor, and the method further comprises:
in response to the difference being less than the second threshold, turning on the fourth positive transistor in response to a second logic state of the second comparison result to add the unit feedback signal to the second positive calculation signal for increasing the second calculation signal.
